(19) United States
(12) Patent Application Publication
(10) Pub. No.: US 2026/0278149 A1
(43) Pub. Date: Sep. 17, 2026

(54) COGNITIVE QUERY INTERPRETER ENGINE IN A SECURITY MANAGEMENT SYSTEM

(71) Applicant: Microsoft Technology Licensing, LLC, Redmond, WA (US)

(72) Inventors: Xinye TANG, Issaquah, WA (US); Alexander Sasha Stojanovic, Providence, RI (US); Ye Xing, Wellesley, MA (US); Yogesh Kant Roy, Redmond, WA (US); Daniel Lee Mace, Bellevue, WA (US); Haijun Zhai, Bothell, WA (US); Alexander David Klein, Seattle, WA (US)

(21) Appl. No.: 19/081,684

(22) Filed: Mar. 17, 2025

(51) Int. Cl. G06F 21/62; G06F 21/55; G06F 40/30

(52) U.S. Cl. CPC G06F 21/6227; G06F 21/552; G06F 40/30

(57) ABSTRACT

Methods, systems, and computer storage media for providing cognitive query interpretation using a cognitive query interpreter engine of a security management system are described. Cognitive query interpretation refers to the ability of the cognitive query interpretation engine to understand and process queries in a way that mimics human cognitive reasoning. This involves interpreting natural language inputs, identifying the user's intent, and dynamically selecting and querying appropriate data sources—such as logs, APIs, and threat intelligence databases—across different systems and technologies. The cognitive query interpretation engine interprets the query contextually, taking into account factors like user preferences, historical interactions, and the specific security scenario, to provide actionable responses. It leverages contextual analysis and neuro-symbolic reasoning to ensure actionable insights from complex datasets, transforming how users interact with and extract data. This not only enhances the user experience but ensures that users can continue their investigation or analysis with minimal friction.

### BACKGROUND

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, cloud security posture management (CSPM) and enterprise security posture management can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing cognitive query interpretation using a cognitive query interpretation engine of a security management system. Security management generally refers to planning, implementing, controlling, and monitoring security measures to protect assets, resources, and information from various threats and risks in computing environment. Cognitive query interpretation refers to the ability of the cognitive query interpretation engine to understand and process user queries in a way that mimics human cognitive reasoning. This involves interpreting natural language inputs, identifying the user's intent, and dynamically selecting and querying appropriate data sources —such as logs, APIs, and threat intelligence databases—across different systems and technologies. The goal is to interpret the query contextually, taking into account factors like user preferences, historical interactions, and the specific security scenario, to provide a seamless, coherent, and actionable response.

Conventionally, security management systems are not configured with a comprehensive computing logic and infrastructure to efficiently interpret user queries that span multiple data sources with different technologies, query languages, and access protocols. Users must manually navigate between disparate tools and interfaces to gather information, leading to fragmented, incomplete, or inconsistent results. This lack of integration means that critical context may be missed, making analysis more cumbersome and error-prone. Additionally, many legacy systems rely on rigid query structures that require users to understand complex languages or templates, which limits flexibility and hinders non-technical users. This lack of adaptability slows decision-making and reduces the overall effectiveness of systems, especially in fast-paced environments like security operations.

A technical solution—to the limitations of conventional security management systems—can include providing a cognitive query interpretation engine that is designed to interpret user queries and provide insights by leveraging natural language understanding, contextual reasoning, and the dynamic orchestration of multiple data sources. The cognitive query interpretation engine processes complex queries by analyzing the user's intent and navigating diverse data environments to deliver accurate and relevant outputs.

The cognitive query interpretation engine supports natural language understanding (NLU), which allows it to process user inputs in natural language. This enables the cognitive query interpretation engine to interpret user queries accurately, breaking them down into specific, actionable components that can be addressed effectively. It then identifies the appropriate data sources and technologies needed to generate a response the user's request.

Beyond basic query matching, the cognitive query interpretation engine applies contextual reasoning by considering factors like user history, preferences, and the context of the query. This context-aware processing allows the cognitive query interpretation engine to generate responses that align with both the immediate request and the user's broader goals. Additionally, the cognitive query interpretation engine uses dynamic data orchestration to integrate and query data from multiple sources, including APIs, databases, and third-party systems. The cognitive query interpretation engine automates the querying process by selecting the relevant data, applying the appropriate query languages, and providing unified, meaningful results without requiring the user to manually interact with multiple tools and formats.

In operation, in a first embodiment, a security query is accessed from a client associated with a user. A user intent of the security query is determined using contextual data associated with the user. The user intent identifies an investigation request associated with the security query. The user intent is associated with a user intent identifier. The user intent identifier is communicated to the client. A user intent refinement input associated with refining the user intent of the user intent identifier is accessed via an interface of the client. Based on the user intent refinement input, an updated user intent is generated. Based on the updated user intent, a data source is identified from a plurality of data sources. The data source is a preferred data source comprising data related to the update user intent.

Based on the updated user intent and the preferred data source, a preferred security query processor is identified from a plurality of security query processors. The preferred security query processor uses natural language processing capabilities user intents and security queries to generate security query outputs. Based on the updated user intent, the preferred data source, and the preferred query processor, an execution plan is generated. Based on the execution plan, a security query output is generated for the security query. The security query output is communicated to the client.

In a second embodiment, a security query from is accessed from a client. A user intent, a preferred data source, a preferred security query processor, and an execution plan are determined. Determining the user intent, the preferred data source, the preferred security query processor, and the execution plan are based on a dialogue interface that supports interactive security query management refinement. Based on the user intent, the preferred data source, the preferred security query processor, and the execution plan, a security query output is generated. The security query output is communicated, the security query output comprises a security recommendation.

In a third embodiment, a security query is communicated from a client. Based on communicating the security query, an execution plan is received at the client. The execution plan is generated based on a user intent, a preferred data source, and a preferred security query processor associated with the security query. An execution plan refinement input is accessed via an interface of the client. The execution plan refinement input is communicated to cause generation of an updated execution plan. The updated execution plan is executed to generate a security query output. The security query output is received. The security query output comprises a security query output explanation associated with the preferred data source and the preferred security query processor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary cognitive query interpreter engine architecture including a cognitive query interpreter engine, in accordance with aspects of the technology described herein;

FIGS. 2A and 2B are block diagrams associated with an exemplary security management system including a cognitive query interpreter engine, in accordance with aspects of the technology described herein;

FIG. 3 provides a first exemplary method of providing cognitive query interpretation using a cognitive query interpreter engine, in accordance with aspects of the technology described herein;

FIG. 4 provides a second exemplary method of providing cognitive query interpretation using a cognitive query interpreter engine, in accordance with aspects of the technology described herein;

FIG. 5 provides a third exemplary method of providing cognitive query interpretation using a cognitive query interpreter engine, in accordance with aspects of the technology described herein;

FIG. 6 provides a block diagram of an exemplary security management system suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

A security management system supports management of security aspects of resources and workloads in computing environments. The security management system can help enable protection against threats, help reduce risk across different types of computing environments and help strengthen a security posture of computing environments-i.e., security status and remediation action recommendations for computing resources including networks and devices. For example, the security management system can provide real-time security alerts, centralize insights for different resources, and provide for preventative protection, post-breach detection, and automated investigation, and response.

Security management systems primarily focus on providing visibility into potential security threats, managing incidents, and responding to various security events. A significant portion of the security landscape is dominated by Security Information and Event Management (SIEM) systems, which collect, aggregate, and analyze log data from multiple sources. These systems are designed to identify patterns, detect anomalies, and alert security professionals to potential threats. However, SIEM systems are often rule-based, relying on predefined conditions to trigger alerts. While they can aggregate data from diverse sources like firewalls, intrusion detection systems (IDS), and network traffic monitors, the integration between these systems is typically manual, siloed, and rigid. This limits the ability to quickly correlate data across different security domains and often leaves gaps in understanding complex threats or emerging attack patterns. Analysts frequently need to manually sift through raw logs and event data to uncover critical information, slowing down response times and making it more difficult to address sophisticated, multi-faceted attacks.

Query processing systems within security management are built on traditional, structured query languages and formats like SQL, KQL (Kusto Query Language), and other domain-specific languages (DSLs) tailored to particular security contexts. These systems allow users to query vast amounts of data, but they are generally designed with specific use cases and data structures in mind, such as extracting information from security logs or network monitoring tools. Queries in these systems are often predefined or manually constructed by analysts with a high level of technical expertise, requiring deep familiarity with the specific query language and data sources. Users typically interact with these systems through specialized interfaces or dashboards, where they input queries to retrieve relevant data, such as log events, access records, or threat intelligence information. However, query processing is often fragmented, as different tools utilize different technologies and query structures, making it difficult to achieve comprehensive insights from multiple sources. While these systems are effective for basic data retrieval, they lack the flexibility to dynamically interpret complex user queries or provide unified insights from a range of heterogeneous data sources. Analysts often need to navigate through multiple systems and interfaces, manually correlating results from various queries and data sources, which is both time-consuming and prone to error.

By way of example, a security operations center (SOC) analyst is investigating a potential security breach and asks, “Show me the failed login attempts and access to sensitive files in the last 24 hours to identify if there are any unusual patterns.” The analyst expects the system to interpret this request, understand that it involves querying authentication logs, access records, and conducting pattern analysis over the last 24 hours. However, the relevant data resides in different systems, with some data accessible via Kusto Query Language (KQL), others through a graph API (e.g., Microsoft Graph API) and some potentially requiring external threat intelligence sources. The problem lies in interpreting this user query and automatically coordinating and querying across these multiple systems, languages, and APIs to produce a coherent response.

Conventionally, security management systems are not configured with a comprehensive computing logic and infrastructure to efficiently interpret user queries that span multiple data sources with different technologies, query languages, and access protocols. In traditional systems, users must manually navigate between disparate tools and interfaces to obtain the information they need. For example, if an analyst is trying to investigate a security incident, they might have to separately query logs using one query language, access threat intelligence data via APIs, and then perform additional analysis in other tools. This fragmented approach requires significant effort from the user to stitch together insights from different systems, often leading to incomplete or inconsistent responses. The lack of seamless integration between various data sources means that analysts may miss critical context making the investigation process more cumbersome and error-prone.

Moreover, these conventional systems often lack the capability to interpret user queries naturally and contextually. Most legacy systems rely on rigid, predefined query structures that require users to understand complex domain-specific languages (DSLs) or structured query formats. This makes it difficult for non-technical users to interact with the system efficiently, as they must either be fluent in the system's language or rely on predefined templates or scripts. As a result, even users with significant domain expertise are often limited in their ability to flexibly explore data and draw insights in an intuitive way. This lack of adaptability and user-centric functionality can significantly slow down decision-making processes and limit the overall effectiveness of systems, especially in fast-paced environments like security operations. As such, a more comprehensive security management system-with an alternative basis for performing secure management operations-can improve computing operations and interfaces in security management systems.

At a high level, the cognitive query interpreter engine is a Natural Language (NL) assistance system designed to dynamically understand user intent, identify the most relevant data sources, and route queries to specialized security query processors (e.g., NL2* modules) including: NL2KQL (Natural Language to Kusto Query Language), NL2API (Natural Language to API), NL2Graph (Natural Language to Graph), NL2GQL (Natural Language to Graph Query Language), among others, to deliver accurate, relevant, and comprehensive responses.

Users are enabled to begin with low-level Domain-Specific Languages (DSL) or API interactions, with stepwise refinement provided toward natural language output. Alternatively, a natural language query may be initiated, leading to a series of DSLs and API calls that fulfill the information needs. The cognitive query interpreter engine can be tailored for security use cases, utilizing contextual refinement and reinforcement learning mechanisms to incorporate user feedback, thereby optimizing model accuracy, utility, and personalization.

Session context, user and tenant session history, and advanced knowledge retrieval agents are leveraged by the system. Users are supported by an interactive chat experience, allowing for refinement of actions and outputs, facilitating deeper exploration, understanding, and search throughout the process. Designed for seamless integration, cognitive query interpreter engine is provided as a system API, ready to enhance various products and workflows with sophisticated, user-driven insights.

By way of illustration, in a security operations center (SOC), an analyst begins the investigation by accessing a security query from a client system. A security query can refer to any request or prompt that the cognitive query interpreter engine processes to extract specific information related to security issues, such as potential breaches, suspicious activities, or threat indicators.

A security query can include request made by a user for information related to security data. These security queries are typically used to investigate potential threats, anomalies, or security incidents. Security queries can vary in complexity, ranging from simple requests for historical data to more complex investigations into system vulnerabilities or security breaches. The interpretation and response to these queries rely heavily on contextual data and user intent, which are critical to delivering the most accurate insights.

The first step of the process involves determining the user intent. User intent is the goal or purpose behind the security query submitted by the user. User intent defines what the user wants to achieve with their query, such as investigating a potential threat or seeking information about a specific incident. The user intent can identify an investigation request that is what the user's query is aimed at analyzing or probing with the goal of gathering detailed information for further examination or action. The investigation request refers to a user's inquiry that seeks detailed information, analysis, or clarification about a specific topic, event, or issue. It typically involves gathering facts, evidence, or further understanding to resolve uncertainties or provide comprehensive insights.

Understanding user intent enables accurately processing security queries because it helps the cognitive query interpreter engine to determine which data sources, processing methods, and security insights are most relevant to the user's needs. In this context, user intent typically relates to an investigation request or an issue that needs to be resolved. This user intent can be determined by the cognitive query interpreter engine and helps to recognize the security issue associated with the query. It serves as a key reference point for maintaining the context of the query and ensures that the results provided are aligned with the user's needs, even as the query is refined or adjusted during the process.

User intent can be generated based on contextual data associated with a user. Contextual data is information about the user's environment, history, and preferences that is used to enhance the understanding of their security query. This contextual data may include session context, user preferences, tenant configuration, and historical interactions, all of which provide deeper insight into the user's behavior and past interactions with the security system. Contextual data enables the cognitive query interpreter engine to adjust its responses based on individual needs, tailoring the security query results to be more relevant and timely.

A user intent identifier can be generated for the user intent. The user intent identifier is a reference, marker, or label that represents the specific intent detected in a user's query, allowing the system to track, categorize, and communicate the identified intent to the user. The user intent identifier acts as reference that defines the specific focus of the query that can be communicated to the client. This user intent identifier may also help the cognitive query interpreter engine correlate the user's intent with relevant data sources, execution plans, and security query processors.

Once the user intent identifier is identified, the cognitive query interpreter engine communicates it back to the client. The user-via the client-can then interact with the cognitive query interpreter engine through a dialogue interface, which is an interactive interface that supports ongoing communication between the user and the cognitive query interpreter engine. This interface allows the client to refine the query and further define the scope of the investigation. Through the dialogue interface, the client provides a user intent refinement input, which helps fine-tune the initial intent.

User intent refinement input is feedback from the client that refines or clarifies the user's intent in relation to the security query. It helps the cognitive query interpreter engine adjust its interpretation of the user's query, ensuring that the security query output aligns more closely with the user's expectations and the security issue at hand. The input may consist of additional instructions, adjustments, or clarifications that modify the user's focus or broaden the scope to include new considerations.

Based on the user intent refinement input, the cognitive query interpreter engine generates an updated user intent based on the initial user intent to reflect the new, more precise security query concern. The updated user intent is a refined version of the original user intent, generated after incorporating user feedback, contextual data, and system-driven insights to better align with the specific investigative goals of the query. This updated user intent allows the cognitive query interpreter engine to identify a preferred data source from a range of available sources. A preferred data source is the data repository or service identified as most relevant to the user's intent. Based on the query's context and the user's request, the cognitive query interpreter engine determines which data source will provide the most meaningful and high-priority information for the task. The selection of a preferred data source ensures that the query is answered with the most applicable and accurate data available.

A preferred data source refers to a particular system, API, or database that holds data (e.g., contextualized information) most relevant to the updated user intent. Contextualized information refers to data that can be dynamically aligned with the updated user intent, ensuring relevance and accuracy for further processing and analysis. These data sources may include first-party data sources (data generated or stored within the organization, such as internal logs or database entries), third-party data sources (external threat intelligence feeds or partner organizations'data), and a security graph, which is a visual representation of connections and relationships between security entities like users, assets, and devices. These data sources are enriched with additional metadata, providing deeper context and aiding in more accurate analysis.

The cognitive query interpreter engine also selects a preferred security query processor from a set of available security query processors. A security query processor is a tool or algorithm designed to process the data associated with a security query, often utilizing advanced techniques such as natural language processing (NLP). The preferred security query processor uses these NLP capabilities to process the updated user intent and generate a security recommendation, which outlines possible threats, risks, or actions that can be taken to address the security issue at hand.

The cognitive query interpreter engine generates an execution plan, which is a set of instructions for resolving the security issue. The execution plan is a set of dynamically generated instructions or steps designed to execute a security query based on the user's intent, the preferred data source, and the security query processor. This execution plan is tailored to meet the needs of the query and ensure that the system's response is both accurate and actionable.

The execution plan acts as a roadmap for how the query will be processed and the desired outcome achieved. The execution plan guides the cognitive query interpreter engine in querying, analyzing, and processing the relevant data to generate a response to the query. The execution plan refinement input may then be accessed, which refers to feedback provided by the client. This input could include textual data that highlights an issue with the execution plan, such as an error, an adjustment to the query, or a new priority to address. This refinement is essential for correcting the initial plan and ensuring its effectiveness.

Once the execution plan is refined, the updated plan is executed, and a security query output is generated. The security query output refers to the results produced after running the query, including both raw data and contextual explanations. This output typically includes a security query output explanation, which breaks down the reasoning behind the results, describes the role of the preferred data source, and clarifies the reasoning used by the preferred security query processor. This explanation ensures transparency, helping the analyst understand how the results were derived.

Task validation operation verify whether a user's request is valid and aligned with the system's capabilities. If the query request falls outside the scope of the system's functionality or cannot be processed as expected, an out-of-scope message is returned to the client. This message indicates that the query cannot be processed further due to limitations in the system or because the query is outside the boundaries of what the system is designed to handle. The system may also suggest alternative actions, helping the analyst refocus the investigation or providing guidance on how to proceed. This operation ensures that only legitimate, executable security tasks are processed, reducing the chances of confusion or misinterpretation.

The final security recommendation provided to the client combines data retrieved from the preferred data source, along with an explanation of the findings. This recommendation guides the analyst on the next steps, whether that's patching a vulnerability, investigating further into certain areas, or executing a security protocol to address the threat. The recommendation might also suggest further queries or refinements to the current security issue based on the analysis of the data.

Throughout the entire process, the cognitive query interpreter engine dynamically adapts to the user's input and context, using techniques like knowledge extraction, knowledge integration, and query adaptation to ensure the security query is processed efficiently and accurately. Knowledge extraction involves the cognitive query interpreter engine's ability to identify relevant data from raw information, while knowledge integration refers to the system's capacity to combine information from different sources into a coherent and meaningful result. Query adaptation ensures the query is modified based on the evolving needs of the user. In this way, the cognitive query interpreter engine provides a comprehensive and user-friendly environment for investigating security concerns, allowing analysts to interact with the data in natural language, refine their queries, and make well-informed decisions on how to address security issues.

Operationally, cognitive query interpreter engine is provided to understand and process user queries in a way that mimics human cognitive reasoning. The cognitive query interpreter combines natural language understanding (NLU) and machine learning, interprets user queries in natural language, converts them into actionable data requests, and delivers insightful, contextually relevant responses.

At its core, the cognitive query interpreter engine leverages security query processors (e.g., NL2* skills)—a set of specialized modules including NL2KQL (which converts natural language into Kusto Query Language (KQL) for querying large datasets), NL2Graph (which interprets queries for a graph to retrieve data from services), NL2API (which enables API calls to external systems) and NL2GQL (which converts natural language to Graph Query Language for querying graph databases). A security query processor is a predefined capability within the cognitive query interpretation engine that supports processing natural language queries and executing tasks such as data retrieval, analysis, or visualization. These processors or skills utilize natural language processing (NLP) and domain-specific knowledge to interpret user intent, query multiple data sources, and generate actionable insights or responses. These processors work seamlessly together to process a variety of query types, whether they are aimed at internal data sources or external platforms.

To understand and generate a response to a query, the cognitive query interpreter engine uses multi-source data integration, pulling relevant data from diverse systems and combining it into a cohesive response. The cognitive query interpreter engine may not rely on structured data; it can apply semantic querying, interpreting the deeper meaning behind the user's request to ensure nuanced, flexible data exploration. This capability is further enhanced by neuro-symbolic reasoning, a hybrid approach that combines structured rule-based logic with machine learning to extract insights from complex graph structures (e.g., Microsoft Security Graph).

To refine its results, the cognitive query interpreter engine continuously analyzes the context in which the query is made. It incorporates contextual analysis, using factors such as user preferences, session history, and tenant configurations to tailor responses for the individual. The cognitive query interpreter engine also supports contextual enrichment, enhancing the query with relevant external information—whether from a user's past interactions or from other data sources—to boost the accuracy of the output.

When responding to queries, the cognitive query interpreter engine generates an execution plan that outlines the sequence of tasks needed to generate a response to the query. The cognitive query interpreter engine modular nature allows for dynamic integration of different security query processors which may require querying multiple data sources or running complex workflows. This execution plan generation ensures that the correct steps are taken, reducing the likelihood of errors and improving efficiency.

As users interact with the cognitive query interpreter engine, reinforcement learning allows the cognitive query interpreter engine to improve over time by adapting to feedback. It learns from user interactions, optimizing its performance and enhancing future responses. This capability ensures that the cognitive query interpreter engine not only meets user expectations in the short term but also evolves to provide better service in the future.

Moreover, the cognitive query interpreter engine offers personalization to each user, adjusting the flow based on individual roles, preferences, and past queries. This creates a tailored experience where the system anticipates and adapts to the user's specific needs. Additionally, query refinement allows users to modify and clarify their queries, ensuring that they achieve the desired outcomes.

Throughout the process, the cognitive query interpreter engine provides an interactive experience, enabling users to adjust their inputs and further explore data as needed. The cognitive query interpreter engine also proactively offers next step suggestions, guiding users toward the most relevant actions based on the current task. This not only enhances the user experience but ensures that users can continue their investigation or analysis with minimal friction. In this way, the cognitive query interpreter engine integrates natural language understanding, semantic insights, reinforcement learning, and a suite of security query processors to provide intuitive, dynamic, and personalized responses. It leverages contextual analysis and neuro-symbolic reasoning to ensure accurate, actionable insights from complex datasets, transforming how users interact with and extract value from data.

By way of example, in a first use case, a SOC analyst seeks to investigate potential unusual login patterns and access to sensitive files by asking, “Show me all the failed login attempts and access to sensitive files within the last 24 hours to identify if there are any unusual patterns.” The cognitive query interpretation engine begins by processing the user's intent. It identifies that the analyst's request involves an investigation focused on authentication logs, access records, and pattern analysis. The cognitive query interpretation engine then breaks down the query into actionable components, specifically: a timeframe of the last 24 hours, data sources including login attempts and file access logs, and the identification of a saved KQL (Kusto Query Language) query used for extracting authentication and access logs.

From this breakdown, the cognitive query interpretation engine generates an execution plan that determines the necessary security query processors and data sources required to fulfill the query. It uses NL2KQL to extract the authentication and access logs based on the saved KQL query, NLGraph to visualize connections between user accounts and access patterns for anomaly detection, and NL2API to call external threat intelligence APIs, providing additional context on any suspicious IP addresses or entities. The cognitive query interpretation engine integrates data from the logs and threat intelligence sources, triggers the corresponding contextual query workflows, and updates the saved KQL query to align with the latest schema. As a result, the analyst receives a detailed report showing failed login attempts, access to sensitive files, and any unusual patterns highlighted in a graph format. The cognitive query interpretation engine then suggests next steps, helping the analyst decide how to continue the investigation or take necessary actions based on the findings.

In a second use case, a SOC analyst is investigating a Blitz ransomware attack and asks, “Show me the Blitz ransomware attack graph, including all impacted machines and user accounts.” The cognitive query interpretation engine identifies the user's request as an investigative query related to an attack, focusing on incident data, alerts, network connections, and privilege escalation. The cognitive query interpretation engine breaks down the query into the relevant data sources required for investigation: threat intelligence data related to Blitz ransomware indicators, incident data, alert data, asset data, network connection logs, and audit logs.

The execution plan generated by the cognitive query interpretation engine outlines the required security query processors and data sources, using NL2API to call threat intelligence APIs and retrieve Indicators of Compromise (IOCs) associated with the ransomware. It also employs multiple NL2KQL queries to query assets linked to incidents, alerts, and IOCs, network connections related to the impacted entities, and privilege escalation events in audit logs. Additionally, NL2GQL is used to query incidents and alerts related to Blitz ransomware and visualize connections between accounts, assets, incidents, and alerts. The system integrates all data sources and triggers the necessary contextual query workflows. After execution, the cognitive query interpretation engine generates an attack graph summary that includes the attack's starting entry point, impacted accounts and assets, and a timeline of the attack, which is delivered to the analyst through a client. Finally, the cognitive query interpretation engine suggests next steps based on the findings, such as continuing the investigation on specific entities or expanding the scope to include additional accounts.

The cognitive query interpreter engine extends its applicability to a variety of domains where complex data interpretation, contextual reasoning, and real-time decision-making are required. The fundamental principles of symbolic, semantic, and scoring-based reasoning, combined with neuro-symbolic query execution, provide a highly adaptable framework for numerous industries beyond security.

In healthcare, cognitive query interpreter engine can be leveraged for patient data analysis, medical diagnosis support, and predictive analytics. By integrating contextual patient history, symptoms, and medical research data, the engine can assist doctors in forming differential diagnoses, identifying treatment pathways, and predicting disease progression. The ability to filter and refine large-scale patient data through symbolic and semantic interpretation ensures that only the most relevant medical insights are surfaced, improving diagnostic accuracy and patient care.

For example, when a doctor inputs a query such as “identify possible conditions for a patient with chronic fatigue and muscle weakness,” the cognitive query interpreter engine follows structured processing steps. It first determines the user intent based on the query and contextual patient history. Next, it identifies the preferred data sources, such as patient electronic health records, recent medical publications, and disease symptom databases. Using an NLP-based medical query processor, the system refines the search, leveraging symbolic and semantic filtering to remove irrelevant conditions. An execution plan is generated to correlate symptoms with known disorders, ranking them by probability. The final output provides a structured differential diagnosis with recommendations for further testing or treatment, accompanied by an explanation of the reasoning behind the results.

For financial services, the cognitive query interpreter engine can enhance fraud detection, risk assessment, and automated regulatory compliance monitoring. By processing transaction logs, behavioral data, and financial patterns, the cognitive query interpreter engine can detect anomalies indicative of fraudulent activities. Using a neuro-symbolic approach, it can also evaluate compliance with evolving financial regulations, ensuring that institutions maintain transparency and accountability. Through continuous refinement and interactive query modification, financial analysts can investigate complex fraud patterns with a high degree of precision.

In the legal domain, the cognitive query interpreter engine can support legal research, contract analysis, and case prediction. By retrieving and analyzing legal documents, precedents, and regulatory texts, the cognitive query interpreter engine can provide attorneys with relevant case law, statutory interpretations, and contractual obligations. The ability to dynamically refine search parameters using personalization info and contextual retrieval ensures that legal professionals receive tailored insights, streamlining case preparation and decision-making.

For scientific research and academia, the cognitive query interpreter engine can facilitate literature reviews, experimental data analysis, and hypothesis testing. Researchers can input broad scientific queries, and the system can refine these based on existing publications, experimental results, and peer-reviewed studies. The dynamic query refinement capabilities allow for iterative hypothesis generation, accelerating discoveries in fields such as genomics, materials science, and climate modeling.

In e-commerce and customer service, the cognitive query interpreter engine can enhance recommendation systems, sentiment analysis, and chatbot interactions. By analyzing customer queries, purchase histories, and behavioral trends, businesses can generate personalized product recommendations. Sentiment analysis can be applied to customer feedback and social media data, enabling proactive customer support and brand reputation management. The ability to modify and refine customer queries interactively ensures that automated service systems provide accurate and contextually relevant responses.

The applicability of this solution extends further into smart city management, logistics, and supply chain optimization, where real-time data from multiple sources needs to be processed efficiently. The ability to integrate symbolic reasoning with semantic understanding allows municipalities to analyze traffic patterns, energy consumption, and urban planning needs. In logistics, optimizing warehouse inventory, route planning, and demand forecasting becomes more intelligent through continuous refinement of supply chain data.

By providing an adaptable framework that dynamically refines queries, integrates diverse data sources, and supports interactive feedback, the cognitive query interpreter engine architecture serves as a foundation for intelligent decision-making across a wide range of industries. Its ability to process structured and unstructured data through a multi-layered reasoning approach ensures scalability, accuracy, and efficiency in complex analytical tasks.

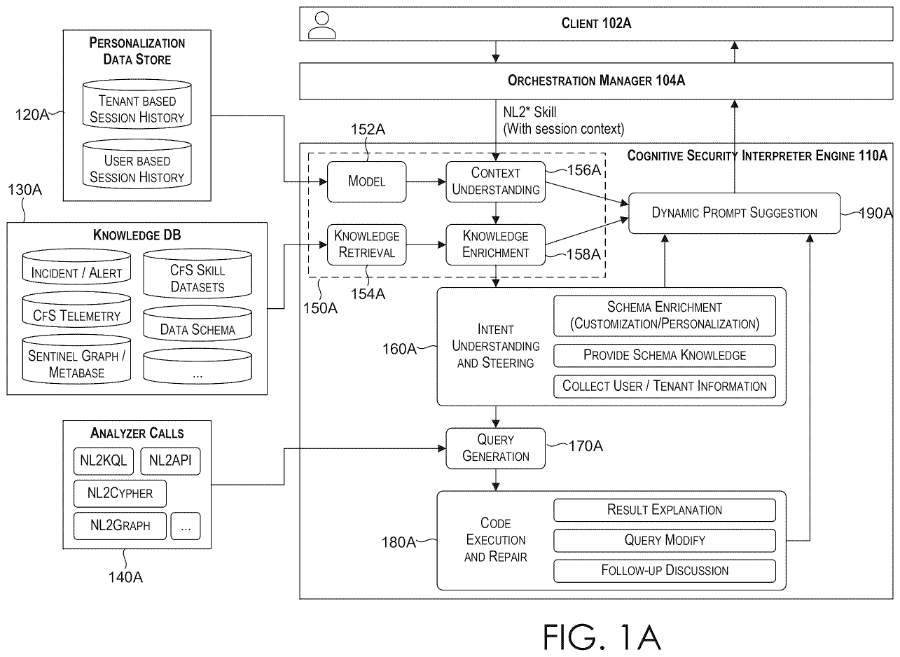

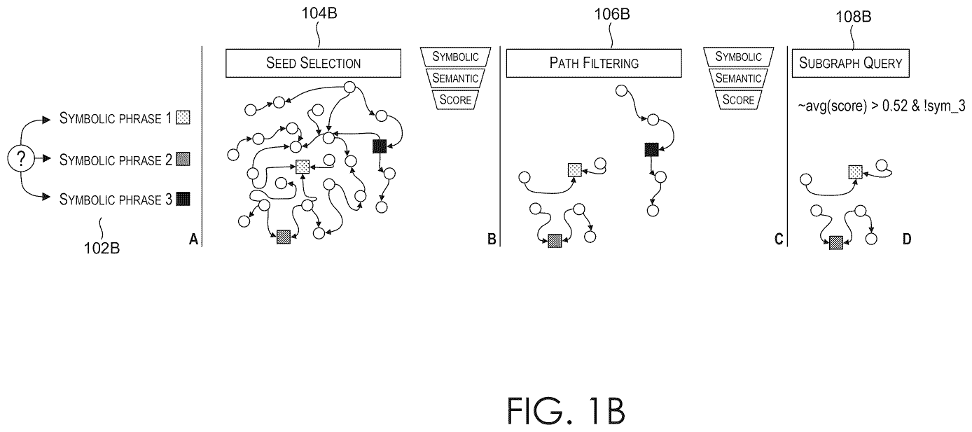

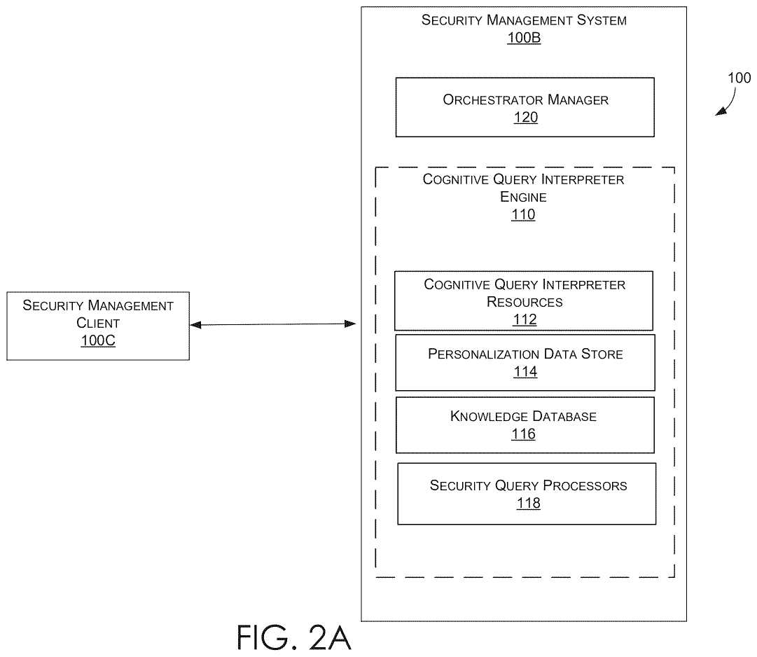

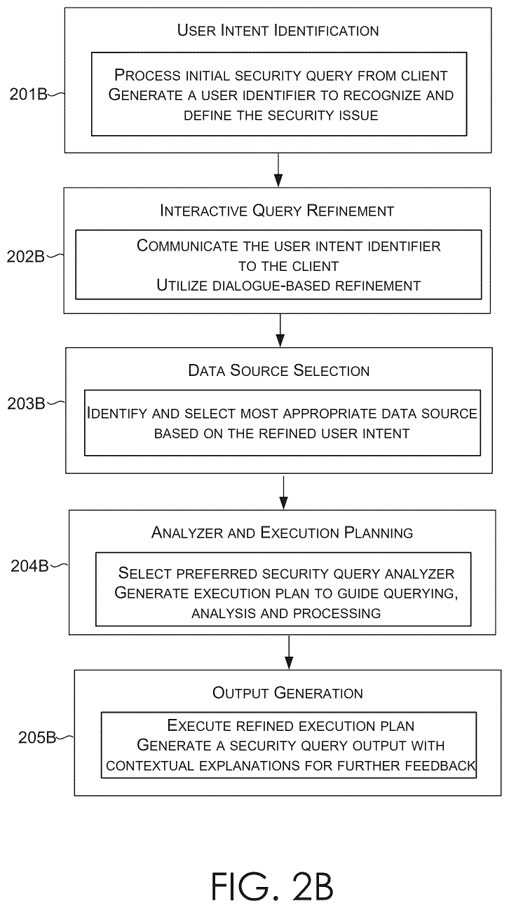

Aspects of the technical solution can be described by way of examples and with reference to FIGS. 1A, 1B, 2A and 2B. FIG. 1A illustrates a cognitive query interpreter engine architecture 100A that includes client 102A, orchestration manager 104A, cognitive security interpreter engine 110A, personalization datastore 120A, knowledge database 130A, analyzer calls and 140A. Cognitive query interpreter engine architecture 100A illustrates an overarching framework that supports intelligent security query processing. Cognitive query interpreter engine architecture 100A integrates multiple functionalities, including contextual analysis, query refinement, data retrieval, execution planning, and dynamic response generation. It facilitates coordinating how the cognitive security interpreter engine 110A processes and interprets queries by incorporating various advanced techniques such as natural language processing (NLP), neuro-symbolic reasoning, and context-aware data retrieval. Cognitive security interpreter engine 110A designed to understand and respond to security queries with a high degree of accuracy by integrating data from various sources.

Client 102A refers to a client devices or external system that can be associated with a user. Client 102A interacts with the cognitive security interpreter engine 110A to submit security queries and receive actionable insights. Users could be security analysts, administrators, or automated systems that send queries to the cognitive security interpreter engine 110A for processing. Client 102A also receives the results or insights from the cognitive security interpreter engine 110A, helping them understand security issues, take corrective actions, or gain a deeper analysis.

Orchestration manager 104A serves as the coordination hub for managing the interactions between the various components of the cognitive security interpreter engine 110A. Orchestration manager 104A ensures that the workflow across multiple integrated platforms (e.g., security products) are coordinated. It controls the flow of information and tasks between modules to ensure query processing and response generation.

Cognitive security interpreter engine 110A is the core processing unit responsible for interpreting security queries and generating insights using advanced techniques like natural language processing (NLP), contextual analysis, and neuro-symbolic reasoning. Cognitive security interpreter engine 110A acts as the engine that processes user queries by understanding the intent, extracting relevant data from sources, and applying reasoning capabilities to generate meaningful responses. Cognitive security interpreter engine 110A also employs advanced machine learning models to comprehend and respond to natural language security queries.

Personalization data store 120A stores data specific to the user and the tenant, such as session history and preferences, to enable personalized query processing. Personalization data store can be used to customize the query responses based on past interactions and preferences. By using tenant-based and user-specific session history, the cognitive security interpreter engine 110A can tailor security query results to reflect the context of each user's role, preferences, and historical actions.

Knowledge database 130A is a centralized repository of security-related data, this database contains logs, telemetry, security graph data, and skill datasets that are used to enrich the security query responses. The knowledge database provides essential real-time and historical data that helps enhance the context of the user's query. This information, ranging from incident/alert logs to security graphs, is retrieved and enriched to offer insights that are directly relevant to the user's current security investigation.

Security query processor calls 140A is a suite of natural language-based query analyzers, such as NL2KQL, NL2API, NL2Cypher, and NL2Graph, used to process and convert natural language queries into structured queries. These security query processor calls bridge the gap between natural language input from users and the structured query languages required by various data sources. NL2KQL (Natural Language to KQL), NL2API, and NL2Graph are specific analyzers that convert user queries into formats understood by KQL (Kusto Query Language), APIs, or graph queries, respectively.

Personalization data and knowledge data processing 150 is based on model 152A and knowledge retrieval 154A components. Model 152A processes personalization data and generates an understanding (i.e., context understanding 156A) of the user's specific context. Model 152A helps to tailor the interaction and forward relevant information for dynamic prompt suggestion The model analyzes user-specific and tenant-specific data to create context-aware recommendations. It then sends this context understanding 156A to the dynamic prompt suggestion module for providing relevant query refinements and follow-up actions.

Knowledge retrieval 154A is responsible for retrieving relevant security information from the knowledge database 130A, performing enrichment (i.e., knowledge enrichment 158A) of the data, and sending knowledge enrichment 158A to the dynamic prompt suggestion module for enhanced query results. Knowledge retrieval 154A component ensures that the query response is enriched by pulling up relevant data from the knowledge repository. It adds context to the query results by integrating data from incident logs, security telemetry, or other relevant data sources.

Intent understanding and steering 160A uses context understanding 156A and knowledge enrichment 158A to refine the user's query, enrich a schema for customization and personalization, and steer the query towards a more relevant and personalized response. It processes user data, provides schema enrichment based on the user's intent, and gathers additional tenant-specific or user-specific information to further refine the query. It ensures the query is aligned with the user's goals and can suggest query adjustments.

Query generation 170A generates structured queries based on inputs from the security query processor calls 140A and Intent understanding and steering 160A components. Query generation 170A converts the insights gathered from user intent, knowledge enrichment 158A, and context understanding 156A into a query format that can be executed by the system's various data sources or security query processors. Query generation 170A can generate a natural language-enriched query is a query that has been enhanced with additional semantic context, often derived from natural language processing (NLP) techniques, to make it more context-aware and interpretable. The natural language-enriched query combines elements of structured query language with natural language components to improve understanding, precision, and relevance when interacting with databases or security systems, allowing users to express complex or ambiguous intentions in a more human-readable format. This helps bridge the gap between natural language input and structured query execution.

Code execution and repair component 180A executes generated queries, performs post-processing functions, and provides feedback for query adjustments and refinements. It executes the generated structured queries and produces the query output. If errors are encountered during execution, the cognitive security interpreter engine 110A refines the query and executes again. It also offers result explanations, query modifications, and follow-up discussions to ensure continuous refinement of the security investigation.

Dynamic prompt suggestion 190A enhances user interaction by suggesting refinements and follow-up actions based on context understanding, knowledge enrichment, intent understanding, and execution feedback. Dynamic prompt suggestion 190A guides the user in refining their security query, providing suggestions for improvements or next steps in the investigation. It dynamically adapts its recommendations based on the real-time data, enriching the user's experience and ensuring that the query remains aligned with the user's evolving needs.

In this way, each component of the cognitive query interpreter engine architecture 100A works together in an integrated and dynamic way, ensuring that security queries are processed intelligently, efficiently, and personalized for each user. By using a combination of NLP, neuro-symbolic reasoning, and contextual analysis, the cognitive security interpreter engine 110A continuously refines its understanding of the user's intent, ensuring that the output is both accurate and actionable.

With reference to FIG. 1B, FIG. 1B illustrates a neuro-symbolic query processing framework that refines structured queries using a combination of symbolic, semantic, and scoring-based reasoning techniques. It illustrates an adaptive query refinement pipeline that enhances decision-making through intelligent filtering and execution. The process consists of the following stages:

At step 102B—Input Stage, where symbolic phrase extraction starts based on analyzing input queries composed of multiple symbolic phrases, each representing a distinct component of a security or investigative query. These phrases serve as structured inputs for further processing and are passed to the next stage for refinement.

At step 104B—Seed Selection, where initial node identification is performed to identify initial candidate nodes (seeds) within a knowledge graph or security database to expand the query. A mix of symbolic, semantic, and scoring techniques is applied to determine the most relevant nodes. This ensures the search space is accurate and contextually relevant for deeper analysis.

At step 106B—Path Filtering, selected nodes undergo further refinement. Potential graph paths are filtered based on additional symbolic and semantic constraints. Irrelevant or low-confidence paths are pruned, ensuring that only meaningful query expansions proceed. This step reduces unnecessary computational complexity and optimizes the query.

At step 108B—Subgraph Query Execution, a final query operates on a refined subgraph extracted from the larger data structure. The system applies a threshold-based filtering mechanism (e.g., ~average(score)>0.52 & ! sym_3) to ensure that only high-confidence nodes contribute to the final result. The outcome is a processed, structured security query optimized for decision-making and analysis.

The framework integrates symbolic (rule-based) and semantic (context-aware) reasoning to refine security-related queries. Graph-based analysis is used to select and refine query components before executing structured database queries. A scoring mechanism ensures that only high-confidence results are included, improving the accuracy of security investigations.

In this neuro-symbolic reasoning and querying in cognitive query interpretation leverages a combination of neuro-symbolic reasoning and semantic insights to enhance data querying capabilities, especially when working with complex graph structures. This approach integrates fixed query structures, such as a Domain-Specific Language (DSL) like Subgraph Query Language, with semantic understanding. By combining these elements, cognitive query interpretation can provide a powerful and flexible method for data retrieval, enabling richer exploration and more accurate responses.

One key feature of this system is relationship identification. It utilizes both fixed graph types (predefined structures in the graph) and semantic context (meaning derived from relationships within the data) to discover meaningful connections across various data sources. For instance, by understanding the context of actions within a graph, the system can uncover hidden relationships that might not be obvious through standard querying methods.

Another core feature is semantic-aware querying, where queries are generated that integrate fixed relationships with semantic insights. This allows for nuanced exploration of data. For example, it can identify users who performed configuration changes by analyzing the semantic context of actions rather than relying solely on predefined relationships in the data model.

The cognitive query interpreter engine also leverages contextual understanding, utilizing security knowledge database (a collection of security-related information and context) to provide contextually rich queries. This includes considering various aspects like user preferences, historical behaviors, and organizational data specifics—factors that improve the precision and relevance of the results returned.

The benefits of this approach are significant. The ability to handle complex questions is enhanced, as the system can use a normalized schema to process intricate queries, ensuring that responses are both deep and accurate. Moreover, the system facilitates enhanced data discovery, enabling the identification of relationships and patterns that might be hidden or difficult to discern using traditional query methods.

The neuro-symbolic approach ensures that cognitive query interpretation can deliver comprehensive and contextually relevant insights, aligning with user needs and expectations. This process begins with a proposed question, which is converted into symbolic key phrases. These key phrases help identify initial seeds within the graph, which are then filtered using symbolic constraints (such as keywords or conditions) followed by a semantic similarity filter. The remaining nodes are passed through a Deep Neural Network (DNN), which predicts inclusion and exclusion criteria based on the data's context.

After the seed nodes are selected, the system expands outwards, applying both symbolic and semantic constraints to decide which neighborhood nodes to include in the search. This process also uses a funnel approach, progressively narrowing down the search space using a trained Gated Recurrent Unit (GRU), a type of recurrent neural network (RNN) that helps predict node inclusion.

Finally, the results are refined using a graph selection language (DSL), which is employed to make threshold decisions about which subgraphs are relevant to answer the query. This ensures that only the most pertinent data is included, allowing for precise, actionable insights that meet the user's needs.

With reference to FIG. 2A, FIG. 2A illustrates a cloud computing environment (system) 100, security management system 100B, security management client 100C; orchestrator manager; cognitive query interpreter engine 110, cognitive query interpreter resources 112, personalization data store 114, knowledge database 116, security query processors 118.

The cloud computing system 100 provides a security management system 110B that is associated with a security management client 100C and cognitive query interpreter engine 110 for providing cognitive query interpretation functionality. The security management system 100B is a centralized platform responsible for managing, monitoring, and enforcing security protocols across an organization's network or system. It integrates with various security services to provide functions such as monitoring, incident response, risk management, and policy enforcement. Security management system 100B collects, analyzes, and takes action on security data, ensuring a proactive approach to handling security events, such as intrusion alerts and breaches.

Security management client 100C, which can either be a security administrator, analyst, or an automated system device, interacts with the cognitive query interpreter engine 110 to submit security queries and receive processed insights. This interaction typically occurs via a user interface or API, allowing the security management client 100C, to prompt for specific security questions related to vulnerabilities, threat detection, or compliance. The security management client 100C inputs are used to define the scope and nature of the security queries, and through this interaction, the security management client 100C receives actionable insights, risk assessments, or remediation recommendations that inform decision-making and response actions.

Cognitive query interpreter engine 110 responsible for interpreting security-related queries using advanced techniques such as Natural Language Processing (NLP), contextual analysis, and neuro-symbolic reasoning. When the security management client 100C submits a query, the cognitive query interpreter engine 110 analyzes the request, identifies the user's intent, and generates a structured response based on relevant security data. Cognitive query interpreter engine 110 processes both the natural language input and the context surrounding it, ensuring that the results are meaningful, accurate, and tailored to the security query.

Cognitive query interpreter resources 112 are specialized resources that assist with query processing and analysis. These resources include NLP models, algorithms for intent recognition, and contextual analysis tools that ensure the cognitive query interpreter engine 110 understands both the explicit content of the query and the underlying context. They enable the cognitive query interpreter engine 110 to accurately interpret security queries, refine them based on user input or additional context, and ultimately provide precise responses. Cognitive query interpreter resources 112 work together to enhance the ability of the cognitive query interpreter engine 110 to process complex queries, adapt to varying security scenarios, and generate the most relevant insights.

Knowledge database 116 is centralized repository for security-related data, including incident logs, telemetry data, threat intelligence feeds, and historical security information. Knowledge database 116 is associate with query processing workflows by providing real-time and historical data that enriches the ability of the cognitive query interpreter engine 110 to interpret security queries accurately. The data within the Knowledge database 116 is used to generate responses, whether it's extracting specific security events, understanding patterns in past incidents, or retrieving critical information related to emerging threats. The comprehensive nature of the Knowledge database 116 ensures that all relevant data is available for contextual analysis, allowing for the generation of actionable, context-aware insights.

Security query processors 118 are specialized components within the system that handle the processing of different types of security queries. These processors leverage advanced query translation techniques such as NL2KQL, NL2API, and NL2Graph to convert natural language queries into structured queries that can be executed against various data sources. Each processor is designed to handle a specific query type, making the system flexible and capable of managing complex queries across different platforms, including databases, APIs, and graph structures. By ensuring that queries are tailored to the data format they need to interact with, these processors enhance the efficiency and accuracy of the query interpretation process, ensuring that each query is processed optimally for its intended data source.

By way of illustration, a user submits a security query through a client interface, seeking to investigate a potential security issue. The cognitive query interpreter engine first uses contextual data—such as the user's session context (e.g., current user interaction state), user preferences (e.g., individual settings or previous interactions), tenant configuration (e.g., organization-specific settings), and historical interactions (e.g., past user activities or tasks).—to determine the user intent of the security query. By processing this data, the cognitive query interpreter engine can clarify and refine the user's security query in a dynamic, interactive dialogue, ensuring that the user's goals are accurately understood and aligned.

The user intent (e.g., via a user intent identifier) is communicated back to the client to determine it appropriately captures the user intent. The user may refine their request via a dialogue interface, providing user intent refinement input to clarify or adjust the security query. Based on this input, the cognitive query interpreter engine generates an updated user intent, which is then used to identify one or more preferred data sources containing the relevant data for the investigation. The one or more preferred data sources may include first-party (1P) data from within an organization, third-party (3P) data integrated through connectors (tools that link external data sources), and various tiers of a security graph), a network of data services and endpoints within the organization that provide security-related information. An important aspect of this process is ensuring that the selected data sources are appropriate and relevant to the user's needs. The cognitive query interpretation engine allows for user confirmation, prompting them to review and adjust the data sources if necessary.

The cognitive query interpretation engine employs its inventory of saved queries from across security products as one of its data sources. By adapting pre-existing queries based on the user's specific context, it can provide more accurate and faster responses, facilitating a smoother experience. These existing queries are enriched with relevant knowledge such as incident or alert information, alert mitigation steps, data schemas, and metadata. By leveraging knowledge extraction and knowledge integration techniques, the cognitive query interpreter engine ensures security queries are processed with the most accurate, context-aware information, delivering insights that are tailored to the user's specific needs and situation.

Based on the updated user intent and the one or more preferred data sources, the cognitive query interpreter engine then selects one or more preferred security query processor, which use natural language processing (NLP) capabilities to understand and process the security query based on the updated user intent. These security query processors or skills refer to specialized modules that translate NL queries into structured commands or API calls, each targeting specific purposes and operating on distinct data sources. If the request falls outside of the security query processors, the cognitive query interpretation engine guides the user toward appropriate solutions, enhancing the experience by rejecting out-of-scope tasks. The cognitive query interpreter engine ensures that no conflicts arise between different NL2* skills by carefully managing their execution.

Once the appropriate security query processors are identified, an execution plan is generated. The cognitive query interpreter engine generates a tailored execution plan—a dynamically generated set of instructions based on the updated user intent, the one or more preferred data sources, and the one or more preferred security query processors. The execution plan is presented to the user for review and potential modifications, ensuring that the output aligns with their expectations. If errors or discrepancies are found in the execution plan, the user can provide an execution plan refinement input to correct the issue, ensuring that the execution plan is aligned with their intent.

The execution plan is executed to retrieve the necessary data from the one or more preferred data sources. In cases where multiple security query processors are needed, the cognitive query interpreter engine can execute them in parallel and select the optimal output for presentation to the user. Executing the execution plan can be based on neuro-symbolic reasoning, which combines structured query formats with semantic understanding to intelligently handle complex, multi-layered queries and provide relevant security insights. The cognitive query interpreter engine generates a security query output that may include visualizations, reports, actionable insights, or other data to help the user understand the results of their query. The cognitive query interpretation engine also offers the ability for interactive refinement, enabling users to further analyze or modify the outputs based on their needs.

To improve the user's experience further, the system suggests relevant next steps, providing helpful guidance on what actions to take next. As part of its ongoing development, the system incorporates AI observability across all steps, continuously evaluating its performance using tools like Nunatak (a tool for tracking and evaluating system performance) and adapting through reinforcement learning (a machine learning process that improves the system through feedback and interactions) based on user feedback.

Finally, the system is designed to be personalized to individual users, tailoring prompts, queries, and processes based on user preferences, roles, and previous interactions. This personalization extends to tenant-specific configurations, allowing for customized tuning based on organizational policies and settings.

With reference to FIG. 2B, FIG. 2B illustrates a flow diagram associated with providing cognitive query interpretation using a cognitive query interpretation engine in a security management system. A cognitive query interpretation workflow can include the following steps:

A step 201B—User Intent Identification: In a SOC, an analyst begins by communicating a security query. The cognitive query interpreter engine generates a user intent for the security query, the user intent is associated with a specific focus of the security query, such as identifying login anomalies or malware tracking. If the user intent is unsuitable, the system provides an out-of-scope message and alternative actions.

At step 202B—Interactive Query Refinement: The cognitive query interpreter engine shares a user intent identifier with the client, who interacts via a dialogue interface to refine the query. The client provides user intent refinement input, adding instructions or clarifications.

At step 203B—Data Source Selection: The cognitive query interpreter engine updates the intent and identifies the preferred data source from internal logs, external threat intelligence, or a security graph, enriched with metadata for accuracy. The client receives a preferred data source identifier and a response to the preferred data source for confirmation or adjustments.

At step 204B—Analyzer and Execution Planning: The cognitive query interpreter engine selects a security query processor for generating structured queries using NLP for understanding and generating security query outputs. An execution plan is generated, influenced by user intent, data source, and analyzer, and refined through client feedback.

At step 205B: Output Generation: The refined plan is executed, generating a security query output with explanations on data sources and analysis methods. The security query output includes findings, next steps like patching vulnerabilities, and query adaptations.

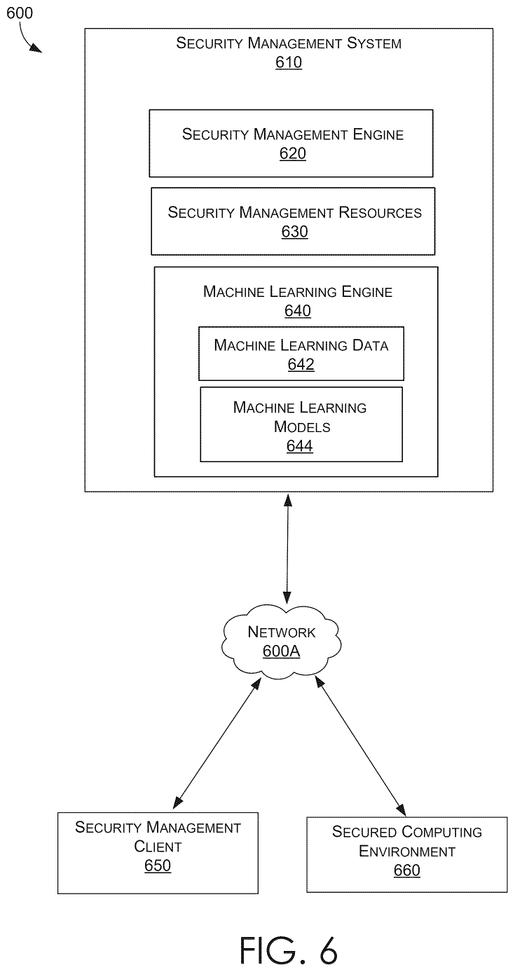

Aspects of the technical solution have been described by way of examples and with reference to FIGS. 1A, 1B, 2A and 2B. FIG. A1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

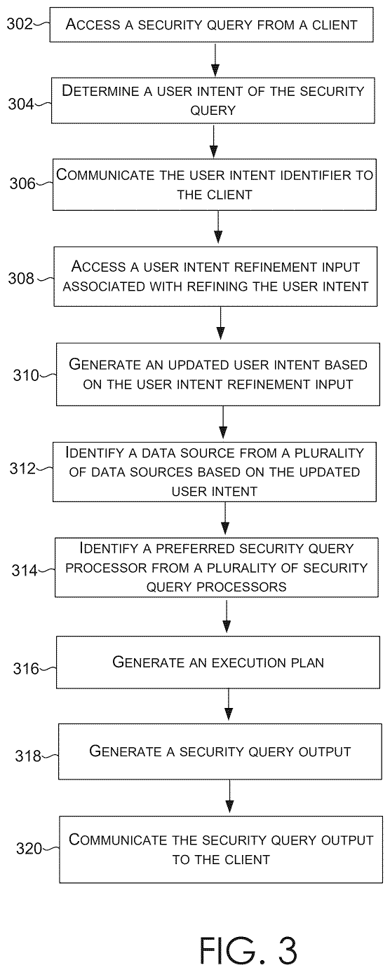

With reference to FIGS. 3, 4, and 5, flow diagrams are provided illustrating methods for providing cognitive query interpretation using a cognitive query interpreter engine of a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system).

Turning to FIG. 3, a flow diagram is provided that illustrates a method 300 for providing cognitive query interpretation using a cognitive query interpreter engine of a security management system. At block 302, access a security query from user associated with a client. At block 304, using contextual data associated with the user, determine a user intent of the security query. The user intent identifies an investigation request associated with the security query, the user intent is associated with a user intent identifier. At block 306, communicate the user intent identifier to the client. At block 308, access, via an interface of the client, a user intent refinement input associated with refining the user intent of the user intent identifier. At block 310, based on the user intent refinement input, generate an updated user intent.

At block 312, based on the updated user intent, identify a data source from a plurality of data sources. The data source is a preferred data source comprising data related to the updated user intent. At block 314, based on the updated user intent and the preferred data source, identify a preferred security query processor from a plurality of security query processors. The preferred security query processor uses natural language processing capabilities to process user intents and security queries to generate security query outputs. At block 3146, based on the updated user intent, the preferred data source, and the preferred security query processor, generate an execution plan, wherein the execution plan is a dynamically generated tailored set of instructions for executing the security query. At block 318, using the preferred security query processor, generate a security query output based on the security query, the updated user intent, and a data from the preferred data source. At block 320, communicate the security query output to the client.

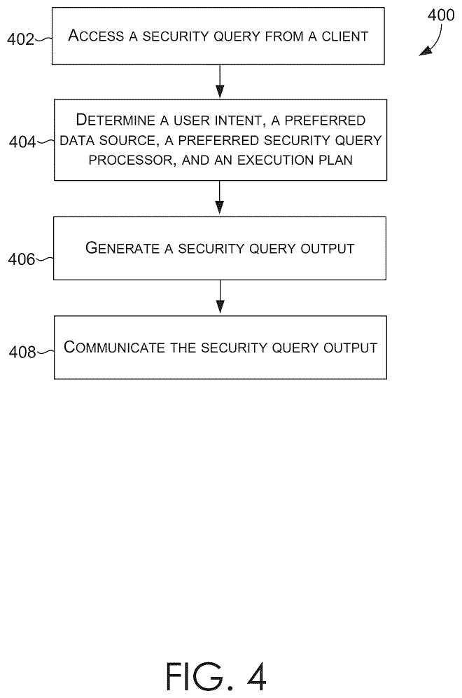

Turning to FIG. 4, a flow diagram is provided that illustrates a method 400 for providing cognitive query interpretation using a cognitive query interpreter engine of a security management system. At block 402, access a security query from a client associated with a user. At block 404, determine a user intent, a preferred data source, a preferred security query processor, and an execution plan. Determine the user intent, the preferred data source, the preferred security query processor, and the execution plan is based on a dialogue interface that supports interactive security query management refinement. At block 406, based on the user intent, the preferred data source, the preferred security query processor, and the execution plan, generate a security query output. At block 408, communicate the security query output.

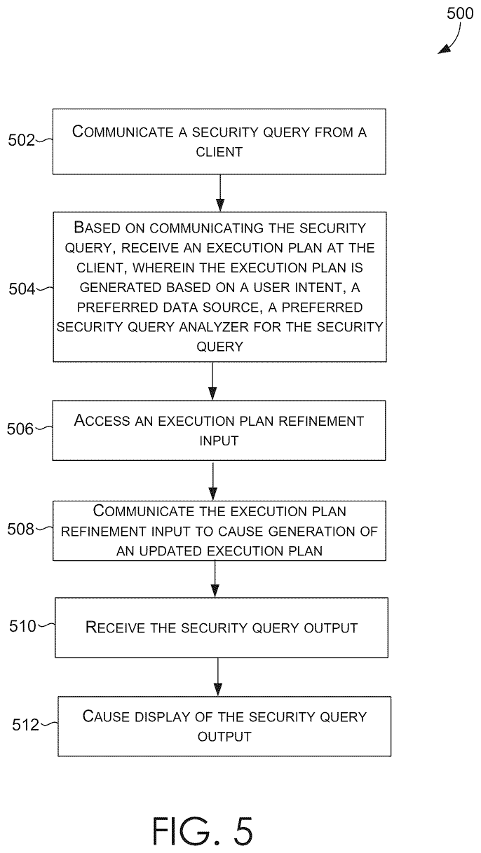

Turning to FIG. 5, a flow diagram is provided that illustrates a method 500 for providing cognitive query interpretation using a cognitive query interpreter engine of a security management system. At block 502, communicate, from a client, a security query associated with a user. At block 504, based on communicating the security query, receive an execution plan at the client. The execution plan is generated based on a user intent, a preferred data source, and a preferred security query processor associated with the security query. At block 506, access, via an interface at the client, an execution plan refinement input. At block 508, communicate the execution plan refinement input to cause generation of an updated execution plan, wherein the updated execution plan is executed to generate a security query output. At block 510, receive the security query output. At block 512, cause display of the security query output.

Embodiments of the present techniques have been described with reference to several inventive features (e.g., operations, systems, engines, and components) associated with a security management system. Inventive features described include: operations, interfaces, data structures, and arrangements of computing resources associated with providing the functionality described herein relative with reference to a cognitive query interpreter engine. Functionality of the embodiments of the present invention have further been described, by way of an implementation and anecdotal examples—to demonstrate that the operations for providing the cognitive query interpreter engine as a solution to a specific problem in security management technology to improve computing operations in security management systems.

By way of illustration, the cognitive query interpreter engine cognitive query interpretation engine processes user queries in three main steps. First, it interprets natural language inputs to understand the user's intent, breaking down the query into key components like data sources, timeframe, and actions needed. Second, the engine applies contextual reasoning, considering factors like user history and preferences to provide more tailored and accurate results. Third, it orchestrates data retrieval across multiple sources, seamlessly integrating information from various systems and tools to deliver unified, actionable insights without the need for users to manually navigate different platforms.

The cognitive query interpretation engine streamlines the process of integrating data from diverse sources, enabling the delivery of more comprehensive and unified insights. By managing multiple data sources simultaneously and orchestrating their interactions, the engine removes the need for users to manually query different systems and tools. This automation improves workflow efficiency and enhances productivity.

With its context-aware query interpretation, the cognitive query interpretation engine goes beyond returning results based on simple keywords. It incorporates contextual reasoning, factoring in the user's history, preferences, and the specific circumstances surrounding the query. This ensures more accurate and relevant results, even in complex or nuanced situations, leading to better-informed decision-making. Additionally, by processing natural language inputs, the engine allows users to interact with the system without needing technical expertise in query languages. This makes the system more accessible, enabling non-technical users to navigate it intuitively.

The cognitive query interpretation engine also excels in dynamic query execution, automatically selecting and applying the most appropriate querying techniques, such as KQL or API calls, based on the unique requirements of each request. This flexibility empowers the engine to handle complex, multi-layered queries across different domains, offering a level of adaptability that traditional query systems typically lack.

Referring now to FIG. 6, FIG. 6 illustrates a computing environment in which implementations of the present disclosure may be employed. In particular, FIG. 6 shows a high level architecture of an example cloud computing platform 600 and security management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing system 100 provides computing system resources for different types of managed computing environments. For example, the cloud computing platform supports delivery of computing services—including compute, servers, storage, databases, networking, and intelligence. The components of cloud computing platform 600 may communicate with each other over a network 600A which may include, without limitation, one or more local area networks (LANs) and/or wide area networks (WANs).

The security management system 610 provides security management functionality for computing environments. The security management system 610 supports planning, implementing, controlling, and monitoring security measures to protect assets, resources, and information from various threats and risks in computing environment. Security management system 610 is configured to trigger alerts for potential or actual threats—including suspicious behavior or malicious behavior—in a computing environment. For example, an alert configuration can be defined to include alert settings, which if met, trigger an alert. The security alert can refer to a human-readable, technical notification regarding current vulnerabilities, exploits, and other security issues associated with a computing environment. The alert can be communicated to a client device that is managed by a security administrator who can then follow up on the alert.

Different types of potential threats and actual threats exist, for example, use of proxies to gain access to a computing environment or unauthorized running of crypto mining software in a computing environment. An attack on a cloud computing environment—for example, performed by a malicious actor—can include several attack operations that are executed to gain access to resources on the cloud computing environment. The attack operations can trigger alerts, when the security system is configured to monitor for these types of attack operations. If multiple attack operations are identified—and a determination that the attack operations are related is made—the alerts associated with the attack operations can be defined as a security incident. The security incident can refer to a collection of correlated alerts and corresponding security data that make up a story of an attack. The attack story can be associated with a security graph and an attack path definition that identifies attack objects (e.g., attack operations, compromised resources, file locations and file types). The attack path can describe how an attacker gained access to a computing environment and related operations and computing resources associated with the attack and unauthorized access. A security incident can advantageously combine multiple alerts associated with a single attack to support managing and responding to the security incident.

The security management system 610 includes a security management engine 620 that is a computing environment that supports executing computational tasks associated with the security management system 610. The security management engine 620 can be a hardware or software component that performs computational operations, such as, mathematical calculations, data processing, and algorithm execution. The security management system 610 integrates security management resources 630 into security management system 610 to effectively provide security management in a computing environment.

The security management engine 620 can be a security posture management engine that is responsible for communicating with security management engine client 650. The security management engine client 650 supports client-side security management operations for providing security management in the security management system 610. The security management engine client 650 supports presenting a security posture visualization associated with security management engine output and communicating an indication to perform a remediation action associated with security management engine output. The security management engine 620 operates to provide visibility to security status of resources in a computing environment. Security posture information can be associated with security management engine output. Security posture information can include security management engine output as described herein with regard to the technical solution.

The security management engine 620 includes a security graph API that provides access to a security graph security graph data. The security graph provides telemetry data associated with a plurality of resources in a computing environment. In particular, the telemetry data can be security data that is associated with security providers in a computing environment. The security graph and security graph API can support integrating security alerts from different security providers via an API connector that streams alerts to the security management engine 620.

The security management engine 620 may assess threats and develop risk scores —using risk assessment operations. A risk associated with security management engine output can used to generate security posture information. In particular, a risk score can refer to a numerical value that represents the level of risk associated with a particular security incident associated with the annotation. It takes into account various factors such as the likelihood of the event occurring and the potential impact of the event if it does occur. The risk score is used to prioritize actions and allocate resources accordingly.

The security management engine 620 can further support generating security posture visualizations based on security management engine output. The security posture information can be generated security management engine output such that security posture information is prioritized and filtered. A prioritization identifier (e.g., high, medium, low) can be provided in the security posture visualization in combination with an alert associated with a security incident. Alternatively, a notification associated with the security management information, security prioritization information or the alert can be communicated. Other variations and combinations of communications associated with security management engine output are contemplated with embodiments described herein.

The security management client 650 can support accessing a security posture visualization and causing display of the security posture visualization. The security management client 650 can include the security posture management engine client that supports receiving security posture information associated security management engine output from the security management system 610 and causing presentation of the security posture information. The security posture information can specifically include security posture visualizations associated with the security management engine output. The secure posture visualization can further include remediation actions associated different alerts-including alerts that are associated with the security management engine output. The security management system can be a security management system described in U.S. patent application Ser. No. 18/451,405, filed Aug. 17, 2023, entitled “ARTRIFICIAL INTELLIGENCE ENGINE IN A SECURITY MANAGEMENT SYSTEM,” which is incorporated herein by reference in its entirety.

The security management client 130 can further support executing a remediation action. In particular, the security posture visualization can include a remediation action for an alert associated with security management engine output. The security management client 130 can receive an indication to perform the remediation action associated with security management engine output. Based on receiving the indication to execute the remediation action, the security management client 130 can communicate the indication to execute the remediation action to cause execution of the remediation action.

The security management resources 630 refer to computing elements (e.g., components, capability, or entities) that collectively enable the security management engine 620 operations. The security management resources 630 encompass a spectrum of computing elements, beginning with the diverse operations the security management resources 630 can perform, ranging from complex computations to data manipulations. Interfaces, an integral part of the security management resources 630, provide the means for both user interaction and seamless integration with external systems, ensuring a dynamic and interactive computing experience. The data facet of the security management resources 630 involves various types: input data, which is the information provided for processing; processing data, representing the data manipulated during computational tasks; and output data, the results generated by the security management engine 620. In this way, the security management resources 630 support the security management engine 620 and security management system 610.

Security management resources 630 cognitive query interpreter engine resources that support leveraging contextual information and impact analysis to thwart or mitigate ongoing attacks on a computing environment. Cognitive query interpreter engine resources encompass the core operations, interfaces, and data components within security management system 610, collectively supporting its functionality in overseeing diverse computing environments across the cloud computing platform 600. Operations of the cognitive query interpreter engine resources include understanding the normal behavior and processes within the computing environment. This includes monitoring system operations, network traffic, user activities, and application behavior to establish a baseline of normalcy. When an attack occurs, security analysts can analyze the deviation from normal operations to identify anomalies or suspicious activities. By understanding the context in which these deviations occur, such as the timing, sequence, and frequency of events, analysts can assess the severity and potential impact of the attack. Interfaces, including graphical user interfaces, command-line interfaces, web-based portals, APIs, and integration points, facilitate interaction with administrators, end-users, devices, and other cloud computing systems. Data components encompass the storage, processing, and transmission of data within the computing environment. This includes databases, file systems, memory, and data pipelines. Contextual attack disruption in the context of data components involves monitoring data flows, access patterns, and data integrity to detect and mitigate attacks targeting sensitive information.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The security management client 650 supports access to security management system 610. Security management client 650 provides a graphical or command-line interface for users or administrators to interact with security management system 610, handling tasks such as planning, implementing, controlling, and monitoring security measures to protect assets, resources, and information from various threats and risks in computing environments. The security management client 650 supports centralized security management, security enforcement, and compliance within a computing environment (e.g., organization's infrastructure), empowering efficient security administration and safeguarding resources.

Secured computing environment 660 can refer to a computing environment that is secured using the security management system 610. For example, cloud computing environments provided by cloud providers encompass various types, including public, private, hybrid, and multi-cloud environments, as well as containerized environments. In a public cloud setup, resources are shared among multiple customers and accessed over the internet, with security managed by the provider through measures like network segmentation and encryption. Private clouds, dedicated to a single organization, offer greater control and are secured through strict access controls and encryption, either by the organization itself or a third-party provider. Hybrid clouds combine elements of public and private clouds, requiring integrated security measures across both environments, such as identity federation and consistent monitoring. Multi-cloud environments leverage services from multiple providers, necessitating standardized security policies and controls for consistent protection. Containerized environments, utilizing technologies like Docker and Kubernetes, secure applications through container image scanning, runtime monitoring, and access control. Across all types, the security management system 610 can provide security management, including compliance certifications, threat intelligence, and security consulting, to safeguard data, infrastructure, and applications from evolving cyber threats and ensure adherence to regulatory requirements.

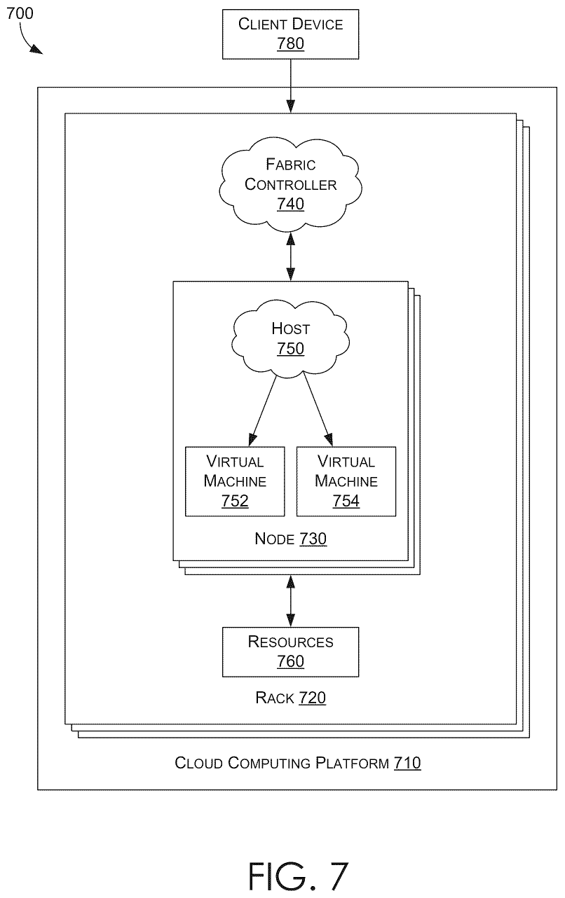

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

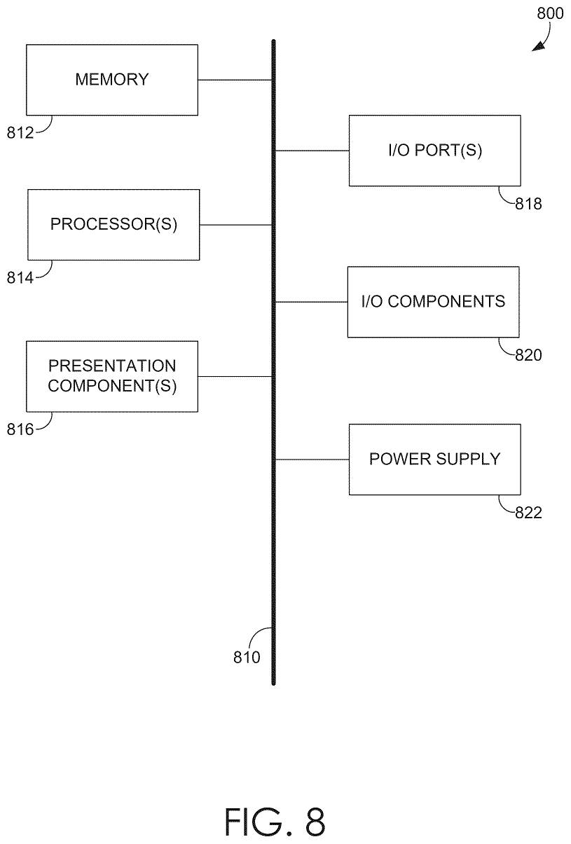

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a security query from a client associated with a user;
using contextual data associated with the user, determining a user intent of the security query, wherein the user intent identifies an investigation request associated with the security query, the user intent is associated with a user intent identifier;
communicating the user intent identifier to the client;
accessing, via an interface of the client, a user intent refinement input associated with refining the user intent of the user intent identifier;
based on the user intent refinement input, generating an updated user intent;
based on the updated user intent, identifying a data source from a plurality of data sources, wherein the data source is a preferred data source comprising contextualized information associated with the updated user intent;
based on the updated user intent and the preferred data source, identifying a preferred security query processor from a plurality of security query processors, wherein the preferred security query processor uses natural language processing capabilities to process user intents and security queries to generate security query outputs;
based on the updated user intent, the preferred data source, and the preferred security query processor, generating an execution plan, wherein the execution plan is a dynamically generated tailored set of instructions for executing the security query;
using the preferred security query processor, generating a security query output based on the security query, the updated user intent and data from the preferred data source; and
communicating the security query output to the client.

2. The system of claim 1, wherein determining the user intent is based on contextual analysis of the security query using the contextual data of the user, wherein the contextual data comprises session context, user preference, tenant configuration, and historical interaction.

3. The system of claim 1, the operations further comprising based on determining the user intent, executing a task validation operation that indicates that the user intent associated with the security query is an out-of-scope request.

4. The system of claim 1, wherein the plurality of data sources comprises first-party data sources, third-party data sources, a security graph, wherein the plurality of data sources are associated with enriched descriptions of the plurality of data sources.

5. The system of claim 1, wherein accessing the user intent refinement input is accessed based on a dialogue interface associated with the client, wherein the dialogue interface supports communicating, to the client, a preferred data source feedback request associated with a preferred data source identifier of the preferred data source; and receiving, via the interface of the client, a response to the preferred data source feedback request.

6. The system of claim 1, wherein determining the user intent further comprises:
generating a natural language-enriched query, wherein the natural language-enriched query is generated based on one or more of: query inventory utilization, query adaptation, knowledge extraction, or knowledge integration.

7. The system of claim 1, wherein a dialogue interface supports communicating, to the client, an execution plan identifier associated with the execution plan;
and receiving, via the interface of the client, a response associated with the execution plan identifier of the execution plan.

8. The system of claim 1, wherein executing the execution plan is based on neuro-symbolic reasoning that combines fixed query structures with semantic understanding, wherein the neuro-symbolic reasoning is based on relationship identification, semantic-aware querying, and contextual understanding.

9. The system of claim 1, wherein the security query output comprises one or more of: a visualization, a report, an actionable insight, and a security query output explanation associated with generating the execution plan.

10. A computer-implemented method, the method comprising:
accessing a security query from a client associated with a user;
determining a user intent, a preferred data source, a preferred security query processor, and an execution plan, wherein the determining is based on a dialogue interface that supports interactive security query management refinement;
based on one or more of: the user intent, the preferred data source, the preferred security query processor, and the execution plan, generating a security query output; and
communicating the security query output.

11. The computer-implemented method of claim 10, the method further comprising based on determining the user intent, executing a task validation operation that indicates that the user intent associated with security query is an out-of-scope request.

12. The computer-implemented method of claim 10, wherein determining the user intent is based on contextual analysis of the security query using contextual data of the user, wherein the contextual data comprises session context, user preference, tenant configuration, and historical interaction.

13. The computer-implemented method of claim 10, wherein the security query output comprises one or more of: a visualization, a report, an actionable insight, and an explanation associated with generating the execution plan.

14. One or more computer-storage media having computer-executable instructions embodied thereon that, when executed by a computing system having a processor and memory, cause the processor to perform operations, the operations comprising:
communicating, from a client, a security query associated with a user;
based on communicating the security query, receiving an execution plan at the client, wherein the execution plan is generated based on a user intent, a preferred data source, and a preferred security query processor associated with the security query;
accessing, via an interface at the client, an execution plan refinement input;
communicating the execution plan refinement input to cause generation of an updated execution plan, wherein the updated execution plan is executed to generate a security query output;
receiving the security query output; and
causing display of the security query output.

15. The media of claim 14, wherein the execution plan is a dynamically generated tailored set of instructions for executing the security query.

16. The media of claim 14, wherein the user intent identifies an investigation request associated with the security query.

17. The media of claim 14, wherein the security query output comprises one or more of: a visualization, a report, an actionable insight, and a security query output explanation associated with generating the execution plan.

18. The media of claim 14, wherein the execution plan refinement input identifies an error in the execution plan.

19. The media of claim 14, wherein executing the updated execution plan is based on neuro-symbolic reasoning that combines fixed query structures with semantic understanding, wherein the neuro-symbolic reasoning is based on relationship identification, semantic-aware querying, and contextual understanding.

20. The media of claim 14, wherein the user is associated with personalization data that supports tailoring security query execution to a customized and personalized experience associated with the user.
